(19) United States
(12) Patent Application Publication
(10) Pub. No.: US 2014/0319245 A1
(43) Pub. Date: Oct. 30, 2014

(54) RECHARGE INSERT FOR CLEANING, SANITIZING OR DISINFECTANT FLUID SPRAY SYSTEM

(71) Applicants: Albert R. Kelly, Douglaston, NY (US); George H. Schmidt, Douglaston, NY (US)

(72) Inventors: Albert R. Kelly, Douglaston, NY (US); George H. Schmidt, Douglaston, NY (US)

(21) Appl. No.: 14/329,907

(22) Filed: Jul. 12, 2014

Related U.S. Application Data
(63) Continuation-in-part of application No. 14/138,276, filed on Dec. 23, 2013.
Application No. 14/138,276 is a continuation of application No. 13/342,127, filed on Jan. 2, 2012, now abandoned.
Application No. 13/342,127 is a continuation-in-part of application No. 29/374,376, filed on Aug. 8, 2011, now Pat. No. D671004.

(51) Int. Cl. B05B 11/00; B65B 3/04

(52) U.S. Cl. CPC B05B 11/0097; B05B 11/3057; B05B 11/0037; B65B 3/04
USPC 239/375; 53/431

(57) ABSTRACT

Rechargeable containers and dispensers, in particular spray bottle dispensers including structures such as strips, pouches, pills, capsules, discs and the like for providing concentrates of chemical agents for charging or recharging the spray bottle dispenser, preferably, individual chemical refill charges containing chemical concentrate are deployed within the spray bottle dispenser to fully contain any inadvertent spillage of chemicals, and to insure a high degree of safety against accidental spills or ingestion. The device is specifically designed for reuse, having a wider opening which is easier to fill, clean and refill without spills, readily accommodates concentrate inserts in any format, minimizes trigger failure, and has a wide base for stability.

### CROSS-REFERENCE TO RELATED APPLICATIONS

This application is a continuation-in-part of U.S. application Ser. No. 14/138,276, filed Dec. 23, 2013, which in turn is a continuation-in-part of U.S. application Ser. No. 13/342,127, filed Jan. 2, 2012, now abandoned, which in turn is a continuation-in-part of U.S. application Ser. No. 29/374,376 filed Aug. 8, 2011, which issued to U.S. Pat. No. D671,004 on Nov. 20, 2012. Each of the prior referenced applications and patents are incorporated herein in their entirety by reference thereto.

### TECHNICAL FIELD

This invention generally relates to spray bottle systems for dispensing cleaning, sanitizing and/or disinfectant fluids, and more particularly, to a recharge insert for use with such systems.

### BACKGROUND OF INVENTION

Due to regulations curtailing the use of aerosol dispensers for chemical reagents that discharge foaming or pressurized gases or hydrocarbons into the atmosphere, the use of spray bottles that are manually pumped has become widespread. The typical spray bottle dispenser consists of a plastic container holding fluid with chemical reagent dissolved therein, which is sealed by a threaded cap mounting a sprayhead from which a diptube projects and extends downwardly into the body of the container. When the user operates a trigger on the sprayhead, the contents are pumped up into the sprayhead and sprayed out from a directional orifice or nozzle.

Many vendors sell separately bottles of fluid for refilling the spray dispenser bottle, or for transferring the sprayhead thereto when the contents of the first-purchased dispenser bottle are used up, so that the sprayhead and bottle can be reused. Often, the refill bottles contain a large volume of fluid so that the original dispenser bottle can be refilled more than one time before another bottle needs to be purchased.

This widely used type of spray dispenser system has several problems, which the present invention seeks to lessen or eliminate. One problem is that the refill bottles take up a lot of space or volume, which incurs additional shipping costs, storage costs, and demand for shelf space. Another problem is that a refill bottle must be sold for the specific types of fluid it is intended to use in the refilling of the refill system. Thus, if a vendor sells different formulations of the same cleaner or different types of cleaners under the same product name, then a refill bottle must be sold for each grade and type of fluid.

A further problem is that pouring fluid from the refill bottle can incur spills or require potentially hazardous handling of caustic or toxic fluids. On the other hand, if the fluids must be made in very dilute concentrations for public safety in handling, then the cleaning ability or effectiveness of the product may be compromised. The refill bottles themselves are discarded after use, thus adding to the solid waste problem.

There have been various proposals for providing a rechargeable insert holding chemical in concentrated form which can be used with a spray dispenser system. For example, U.S. Pat. Nos. 3,655,096, 3,966,089, 4,088,246, and 5,421,483 show a capsule or cartridge holding concentrated material which is secured in the neck of the bottle and released by threading the sealing cap or a ringnut against it to puncture its bottom walls against a sharp element or to squeeze the concentrate out. These types of puncturable or burstable cartridge systems are costly to fabricate, complicated to operate, and potentially hazardous if a problem occurs and the user must open the container and reposition or remove a failed cartridge.

U.S. Pat. No. 5,529,216 shows another rechargeable spray dispenser system in which an elongated insert having one or more concentrate-containing compartments is inserted into the bottle, and a sharp end of the diptube is used to puncture through upper and/or lower sealing membranes in order to release the concentrate into the diluent fluid (water) filled into the bottle. However, this type of recharge insert necessitates a sharp-pointed diptube, as opposed to blunt ended diptube and filters normally supplied. Moreover, the inner seal must be punctured by the user thereby presenting a risk that concentrate will be spilled by the user. U.S. Pat. No. 6,540,109 discloses a rechargeable spray bottle dispenser including at least one chemical reservoir received within the bottle. The reservoirs contain concentrated chemicals which can be released into the bottle by bursting, puncturing or other suitable means. This type of design requires the modification of the spray bottles at the point of manufacture and cannot be used economically on the conventional spray bottles.

Sleevelet recharger designs have been in commercial use for several years in food service establishments where refillable spray bottles are used routinely. Historically they have been recharged with liquid concentrates, as opposed to powders or tablets, dispensed from larger containers, or automatically from captive blending centers. The prior use of spray bottle refills in these establishments and their employees' training to use clearly defined systems helped to make their adaptation to the use of the instant recharge system relatively seamless. Home use of spray bottle refills, however, has never been firmly established, even though their significant cost and space-saving opportunities have been promoted and recognized

U.S. Pat. No. 6,250,511 shows dry-to-the touch elongated inserts, which contain chemicals that can be dissolved in water for cleaning purposes. These inserts are slipped onto the diptube of a spray bottle trigger, which incorporates a retainer device at the bottom of the diptube, which facilitates removal of the wet sleeve after activation. Another retainer design is described in U.S. application Ser. No. 10/934,960 filed Sep. 7, 2004. All of the foregoing patents and applications are incorporated herein by reference.

The technology disclosed in U.S. Pat. No. 6,250,511 has been in commercial use for several years in food service establishments where refillable spray bottles have been used routinely for many years. Historically they have been recharged with liquid concentrates, as opposed to powders or tablets, dispensed from larger containers, or automatically from captive blending centers. The preference for use of the recharge system was driven by its demonstrated ability to reduce both shipping and inventory costs up to 90%.

Although the prior use of spray bottle refills in these establishments and their employees' training to use clearly defined systems helped to make their adaptation to the use of the instant recharge system relatively seamless, home use of spray bottle refills has never been established, even though the significant cost and space-saving opportunities have been promoted and recognized

Extensive consumer research has indicated that broad scale home use of the spray bottle recharge system of the invention would be encouraged if its actual use could be simplified, and if its potential economies in terms of cost and space, and in terms of its potential to significantly reduce solid waste disposal were actively promoted. The refinements and improvements of the original recharge technology, as described herein, are intended to make that possible.

The aforementioned U.S. Pat. No. 6,250,511 and prior application Ser. No. 10/934,960 describe recharge sleevelet devices comprised of nonwoven fibrous materials impregnated with cleaning, sanitizing, disinfecting and other liquid concentrates that are specially designed and constructed to fit onto and extend upwardly on the diptubes of standard spray bottle assemblies.

Whereas these sleevelet devices are designed for use with standard sprayer systems in use worldwide, there are significant disadvantages that add cost, require customized super-concentrates due to the limited loading capacity of the nonwoven sleeves, involve potentially confusing methods for activating and inactivating the system, and require special components (e.g. retainers, etc.) which otherwise may not be needed. These sleevelets must be sized and shaped to slip on and off the diptubes and to fit into and be removable from standard spray bottle openings of approximately 1 inch in diameter, dedicated custom designed and engineered technology is needed to seal the nonwoven sleeves and to precisely control concentrate loading at acceptable production speeds and costs. The specially designed and custom molded retainer that is attached to the tip of the diptube is also needed to safely extract the impregnated sleeve from its packaging, to place into the spray bottle, and to extract/recover the now de-activated sleeve from the spray bottle.

The recharging system described herein avoids the foregoing pitfalls and provides advantages and improvements as will be seen in further detail below.

The sleeve material and/or each layer thereof comprise a water insoluble, binder-free fibrous substrate. The layers are bonded together without a chemical binder, such as by ultrasonic bonding, stitching, or mechanical or hydraulic entanglement. For example, the layers can be made up of synthetic fibers processed into woven, knitted, or nonwoven forms, or synthetic fibers combined with natural fibers. The substrate can also be a flexible, open-celled foam material. Use of a chemical binder is avoided to prevent such chemicals from being dissolved by and leaching into the fluid, thereby contaminating or reducing the effectiveness of the cleaning, sanitizing or disinfectant solution. The nonwoven substrate can be fabricated and/or processed so that its outer surface has a desired porosity to allow fluid to readily penetrate into the adsorptive material and dissolve the chemical impregnated therein. The fluid penetration is significantly facilitated by the use of sonic bonding or needling in the manufacture of the sleeve material for joining multiple layers to form a unitary composite material. The sonic and needling process leaves pores in the material which allow efficient fluid flow. If there is more than one layer, the layers can be bonded together using any of the above-mentioned bonding methods. Needling clearly offers the added benefit of enhanced fluid flow efficiency. The layer or multiple layers can be made into the sleeve after sealing along the elongated edges using any of the means mentioned above.

In an embodiment of the sleeve, as shown in FIG. 2, two layers of the fibrous material form the sleeve, and each layer is further divided to two layers. The layer facing outside comprises nonwoven synthetic material that provides enhanced structural integrity to minimize the damage to the sleeve during vigorous shaking. The layer facing inside comprises nonwoven synthetic material that is optimized to absorb large amount of cleaning composition. In an alternative mode of the preferred embodiment, each layer of the sleeve comprises three layers, the middle layer being the absorptive layer, and the outmost and innermost layers being structural mechanical stabilization layers. Each layer is needle punched (pores introduced by needling and shown), as the bonding methods for layers comprising multiple layers, which further provides pores that facilitate the liquid flow across the layer(s). The two layers of fibrous material are preferably joined together to form the sleeve by ultra-sonically bonding them along the two elongated edges.

The desired cleaning, sanitizing or disinfectant chemical composition can be impregnated in the matrix material by any suitable means. For example, a simple chemical impregnation process is described in commonly owned U.S. Pat. No. 5,091,102 to Sheridan, which is incorporated in its entirety herein by reference. In the Sheridan process, the matrix substrate is coated with non-aqueous treatment solution so that the resulting material is dry to the touch and has the desired amount of chemical composition impregnated therein so that it can be released by contact with water prior to use. The absorptive material is capable of absorbing a cleaning composition in an amount of up to at least six times of its basis weight. The treatment solution can comprise between about 25% and 75% of at least one glycol compound, between 0.2% and 60% of an antimicrobial component, between about 5% and 45% of a surfactant, and optionally effective amounts of fragrances, dyes and other additives.

The preferred means of holding the sleeve in its position on the diptube and therefore stabilizing it and preventing it from blocking the intake end of the diptube during use or recharging, the latter typically involving vigorous shakings, and the preferred means of facilitating the extraction of spent sleeve from the spray bottle after use, are by the application of a retainer (FIG. 1) onto the lower end of the diptube during manufacture of the diptube before the sleeve has been applied to the tube. Further, in one embodiment, the retainer possesses an inwardly tapered end to facilitate the insertion of the diptube and the retainer into the sleeve before use. One example of a retainer that can be used for this purpose is illustrated in FIG. 3 a and FIG. 3 b. The upper end of the retainer has an opening larger than the outside diameter of the diptube, and an inside diameter that can allow the retainer to tightly fit onto the lower end of the diptube. The lower end of the retainer has an inside diameter that is smaller than the outside diameter of the diptube, and therefore does not allow the diptube to protrude out of the lower end of the retainer. The lower end of the retainer further has an outside diameter that is significantly smaller than the diameter of the sleeve opening, allowing the diptube and the retainer to be easily inserted into the sleeve in the absence of direct finger contact with the treated sleeve by the users. Multiple ridges are provided on the outside surface of the retainer in a radial manner to increase the maximum effective outside diameter of the retainer structure. The retainer is attached to the lower end of the diptube before use, i.e., in manufacture as in the preferred embodiment, but can be separate and applied after the sleeve has been applied to the diptube. The combination of the diptube and the retainer in manufacture or the subsequent tight fitting attachment of the retainer to the diptube, and the enlarged effective diameter of the retainer through the introduction of the ridges can prevent the sleeve from slipping downwardly on the diptube and allow easy removal of the spent sleeves which tend to be heavier, wet and flimsy after use. The lower end of the retainer possesses at least one opening to the side. The opening allows the solution to flow into the diptube as when the lower end of the retainer is in contact with the bottom of the spray bottle. Because diptubes employed in various commercial spray bottles may possess different outside diameters, in the case of the separate retainer and diptube multiple retainers would be necessary for typical daily recharging operations with each combination of the upper end and lower end inside diameters optimized for a diptube with a particular outside diameter. Preferably, in this case, instead of having two distinct inside diameters for the upper and lower ends, the retainer can possess a void with a conical shape, with the upper end opening larger than the lower end opening. Retainers designed in this manner have the potential of universally fitting diptubes with different outside diameters, provided that the upper end opening is large enough to accommodate the outside diameter of the thickest diptubes, and the lower end opening is smaller than the outside diameter of the narrowest diptubes. Another design of the retainer can have multiple inside diameters in the central void in a decreasing and stepwise order from the upper end opening to the lower end opening. Retainers designed in this manner also possess the capability of universally fitting diptubes with different outside diameters.

FIG. 4A depicts a three dimensional view of a preferred embodiment of a retainer (FIG. 1). FIG. 4D is a cross sectional view of FIG. 4B along line A-A. As depicted in FIG. 4D, the retainer is conically shaped having a point to facilitate the insertion of the diptube and the retainer into the sleeve before use. The upper end of the retainer has an opening larger than the outside diameter of the diptube, and an inside diameter that can allow the retainer to fit snugly onto the lower end of the diptube.

The lower end of the retainer has an inside diameter that is smaller than the outside diameter of the diptube, and therefore does not allow the diptube to protrude out of the lower end of the retainer. Because of the retainer's conical shape, the lower end of the retainer comes to a point, which is smaller than the diameter of the sleeve opening, thus allowing the diptube and the retainer to be easily inserted into the sleeve in the absence of direct finger contact with the treated sleeve by the users. Multiple ridges are also provided on the outside surface of the retainer in a radial manner to increase the maximum effective outside diameter of the retainer structure.

As in other embodiments of the retainer, the retainer is preferably attached to the lower end of the diptube before use, i.e., in manufacture as in the preferred embodiment, but can be separate and applied after the sleeve has been applied to the diptube. The combination of the diptube and the retainer in manufacture or the subsequent tight fitting attachment of the retainer to the diptube, the enlarged effective diameter of the retainer through the introduction of the ridges, and the square-cut shoulder ensures that the retainer retains the sleeve onto the diptube and can prevent the sleeve from slipping downwardly on the diptube and allow easy removal of the spent sleeves which tend to be heavier, wet and flimsy after use.

The lower end of the retainer possesses at least one opening to the side. The opening allows the solution to flow into the diptube when the lower end of the retainer is in contact with the bottom of the spray bottle. Because diptubes employed in various commercial spray bottles may possess different outside diameters, in the case of the separate retainer and diptube multiple retainers would be necessary for typical daily recharging operations with each combination of the upper end and lower end inside diameters optimized for a diptube with a particular outside diameter. Instead of having two distinct inside diameters for the upper and lower ends, the retainer can possess a tapered void to accommodate different sized diptubes.

In the case of a disc-shaped recharge insert, as is shown in FIG. 10, the disc is inserted into the container as shown and described below: the disc is removed from the packet containing the same by opening the packet and allowing the disc to drop into the container and fall down through the diluent contained therein if it has previously been filled into the container body. If the retainer is to be used separately and specifically dropped into the container before filling the container with water, disc-shaped recharge inserts for use in this manner have the potential of universally fitting diptubes with different outside diameters, provided that the upper end opening is large enough to accommodate the outside diameter of the thickest diptubes, and the lower end opening is smaller than the outside diameter of the narrowest diptubes.

The retainer whether integral with the diptube or not can be manufactured using various materials with appropriate mechanical strength, ease of manufacturing, low cost, and chemical stability toward typical cleaning, sanitizing and disinfecting compositions. The preferred materials are rigid synthetic polymers. The most preferred synthetic polymers for this purpose are polyesters or polypropylene. Most preferably, the retainer is dimensioned to fit diptubes with a specific diameter, but not necessarily generic diptubes. In this case, the retainer can be optionally manufactured as an integral part of the diptube or fused with the lower end of the diptube.

The sleeve is applied on to the diptube as earlier described.

Of course, other modes for mounting the recharge sleeve on the diptube of a standard spray dispenser can be used, such as those discussed in U.S. Pat. No. 6,250,511.

The invention thus provides a dry-to-the-touch recharge sleeve for allowing convenient use and re-use of a spray dispenser bottle. The recharge sleeve and the retainer are preferably provided together as an entirely self-contained unit which does not require any modification to standard spray dispenser devices for its use. Most preferably, the retainer is dimensioned to fit diptubes of specific outside diameters, but not necessarily only generic diptubes.

A wide-mouthed spray bottle design has been described in U.S. Patent Application Publication No. US 2009-0050640 A1, U.S. patent application Ser. No. 11/892,633, now abandoned, utilizing a custom designed spray nozzle assembly that is attachable to the outer wall of the cylindrical container.

U.S. patent application Ser. No. 29/374,376, which issued to U.S. Pat. No. D671,004 on Nov. 20, 2012, discloses a three-piece unit including (1) a bottle with an opening of 1.5 to 3 inches, incorporating screw-threads for attachment of (2) an adaptor cap, which incorporates female screw-threads to the bottle, and screw-threads for attaching (3) a pump-sprayer device with a trigger handle.

U.S. patent application Ser. No. 12/772,399, which issued to U.S. Pat. No. 8,657,162 on Feb. 5, 2014, discloses a rechargeable liquid spray system for use with a spray dispenser having a container body, a sprayhead mounted with a sealing cap, an elongated diptube and a recharge insert made of a matrix material impregnated with a material for creating a cleaning, sanitizing or disinfecting solution which is inserted into the container body before use. The insert is comprised of a nonwoven fabric matrix, which is impregnated with the chemical composition that is preferably maintained dry-to-the-touch. Thus, the recharge insert is preferably a matrix formed in an elongated shape, wherein the outer top sheet layer is porous to fluid filled into the container body so that the fluid can penetrate into the matrix material and dissolve the chemical composition impregnated therein, while preventing direct skin contact with the chemical composition prior to activation. In the case that the spray bottle is not provided with an insert label, the use of the retainer as described can be eliminated.

The present invention will overcome the disadvantages heretofore encountered, add beneficial capabilities and significantly simplify usage of the system. It is facilitated by making available wide-mouthed bottles with screw threads and an opening of at least two inches, preferably two and one-quarter to three inches, and most preferably two and one-quarter to two and three-quarter inches. Additionally, squeeze bottles of this type are available in convenient 16, 24 and 32 ounce sizes. These can be fitted with a custom molded closure that can accommodate standard screw-cap pump sprayer devices. The pump sprayer is screwed onto an adaptor, which in turn is screwed onto the top of the wide-mouthed bottle, as will be seen in the drawings described below.

In accordance with the invention, the absorbent core material is a synthetic or natural binder-free, nonwoven substrate. The core substrate should preferably be comprised of natural or synthetic fibers such as PLA, rayon, Tencel, and/or other biodegradable substrates that can be needle punched and bonded without the use of chemical binders. The cleaning, sanitizing or disinfectant chemical composition is impregnated in the core substrate by slot coating a precise amount of the chemical concentrate. The absorbent matrix sheet material has a desired porosity to allow fluid to penetrate through the material and dissolve the chemical composition impregnated therein.

When the spray bottle containing the insert is filled with water, sealed, and shaken, the chemical composition becomes dissolved, i.e., goes into solution, thereby creating a ready-to-use cleaning, sanitizing or disinfectant solution that will remain stable and fully active. In the embodiment wherein the insert is an impregnated nonwoven fabric strip, one or multi-layered, the backing material of the subject composite is a self-supporting film, placed within the container, with labeling, if provided, on the side facing outward and for holding the insert in an upright position.

Other objects, features, and advantages of the present invention will be explained in the following detailed description of the invention having reference to the appended drawings.

### SUMMARY OF INVENTION

In the present invention, there is presented a recharge insert, for use with a standard spray dispenser device having a container body for holding fluid; a sprayhead mounted with a sealing cap, spray trigger and a spray orifice or nozzle; an elongated diptube which is inserted into the container body during use, and may have a retainer attached to the lower end of the diptube during manufacture of the diptube. The insert is comprised of adsorptive material. The adsorbent material is impregnated with a chemical composition which will dissolve when contacted with a diluent fluid such as water. The recharge insert is preferably formed in an elongated shape.

In the embodiment of the composite disc-shaped insert, the elongated recharge insert is preferably provided with, at its outer circumference, angular cuts so as to provide a disc approximately the shape of a polygon, i.e., hexagon, octagon, nonagon and the like, for and in its insertion and providing the insert protection and ease of insertion and also spray charge active agents before use and exposing the active agents when the insert is deployed. It should be appropriate that the insert need not be restricted to a certain shape. In the case of the invention, the general elongated shape is preferable.

Preferably, the absorbent composite material is a synthetic or natural binder-free, nonwoven substrate. The composite substrate should preferably be comprised of natural or synthetic fibers such as PLA, rayon, Tencel, and/or other substrates that can be needle punched and bonded without the use of chemical binders. The cleaning sanitizing or disinfectant chemical composition is impregnated in the nonwoven strip shape material by slot coating a precise amount of chemical concentrate. The composite material has a desired porosity to allow fluid to penetrate through the material and dissolve the chemical composition impregnated therein.

When the spray bottle containing the insert is filled with water, sealed, and shaken, the chemical composition becomes dissolved in solution, thereby creating a ready-to-use cleaning, sanitizing or disinfectant solution that will remain stable and fully active.

In a preferred embodiment of the recharge insert or the sleeve composite, the cleaning, sanitizing or disinfectant chemical composition is impregnated into the adsorptive material by slot-coating.

The application/mounting of the sleeve can be achieved without the user touching the sleeve as shown in part 2 of FIG. 1. When the spray bottle is filled with water W, sealed with the sealing cap, and shaken, the chemical composition impregnated in the absorptive material of the sleeve becomes dissolved by the fluid to form a cleaning, sanitizing or disinfectant solution WS.

Obviously, alternative sequences of steps for recharging can be followed. For example, the sleeve can be mounted to the diptube before the retainer is attached at the lower end of the diptube.

The insert can be easily inserted into the container without requiring the user to touch the treated core by hand as shown in part 2 of FIG. 1, thereby eliminating any possibility of direct contact between the user's skin and the treated core containing highly concentrated and potentially skin sensitizing or irritating treatment compositions. When the spray bottle, with insert contained therein, is filled with water W, sealed, and shaken, the chemical composition becomes dissolved, thereby creating a ready-to-use cleaning, sanitizing or disinfectant solution that will remain stable and fully active compared to the use of raw liquid concentrates preparing ready-to-use solutions, these inserts are portion controlled and far safer to handle and use because the matrix is designed to prevent direct skin contact with the chemical composition and is not subject to being spilled, broken or swallowed.

The objects, features, and advantages of the present invention will be explained in the following detailed description of the invention having reference to the appended drawings.

### BRIEF DESCRIPTION OF DRAWINGS

FIG. 1 is a cross-sectional view of a spray bottle apparatus for use in an embodiment of the subject system.

FIG. 2 a is a front elevation view of an opened recharge insert assembly.

FIG. 2 b is a view of an embodiment of the recharge insert assembly packaging.

FIG. 2 c is a cross-sectional elevation of the composite recharge insert assembly shown in FIGS. 2 a and 2 b.

FIG. 3 is a cross-section of an embodiment of a three-ply recharge insert assembly.

FIG. 4 is a cross-section of another embodiment of a four-ply recharge insert assembly.

FIG. 5 is a cross-section of a further embodiment of a multi-ply recharge insert assembly.

FIG. 6 a is a perspective view of a two-ply embodiment of the recharge insert core assembly.

FIG. 6 b is an end view of the two-ply embodiment of the recharge insert core assembly shown in FIG. 6 a.

FIG. 7 is an end view of a four-ply recharge insert core assembly.

FIG. 8 is an exploded view of an embodiment of the subject recharge insert adaptor assembly showing the recharge insert held firmly in an upright position with the labeling facing outwardly.

FIG. 9 is a partial cross-section of the spray recharge system insert shown in FIG. 8 with the bottle in the upright position.

FIGS. 10 a-f are cross-sections of the spray recharge adaptor system showing the disc shaped recharge insert in position within the liquid container holding the liquid for spraying applications, a spray head of a conventional construction engaged above the upper neck opening, the sprayhead having a trigger for withdrawing the liquid contents of the container, and a locating adaptor or collar and a nozzle for spraying the liquid on a surface, wherein the recharge insert is shown in relation to the container sprayhead before and after insertion of the recharge insert into the wide mouthed container.

FIG. 11 is a cross-sectional view of a spray bottle apparatus for use in the rechargeable liquid spray system of the invention.

### DETAILED DESCRIPTION OF THE PREFERRED EMBODIMENTS

The subject rechargeable liquid spray system is comprised of: (a) a container for holding a liquid for spraying applications and having a neck opening sufficiently wide to receive or remove a replaceable spray charge insert; and (b) a spray head engaged above the upper neck opening of the liquid container for reaching liquid from the bottom of the container, the spray head also having a trigger for drawing the liquid and a nozzle for spraying the activated liquid on a surface.

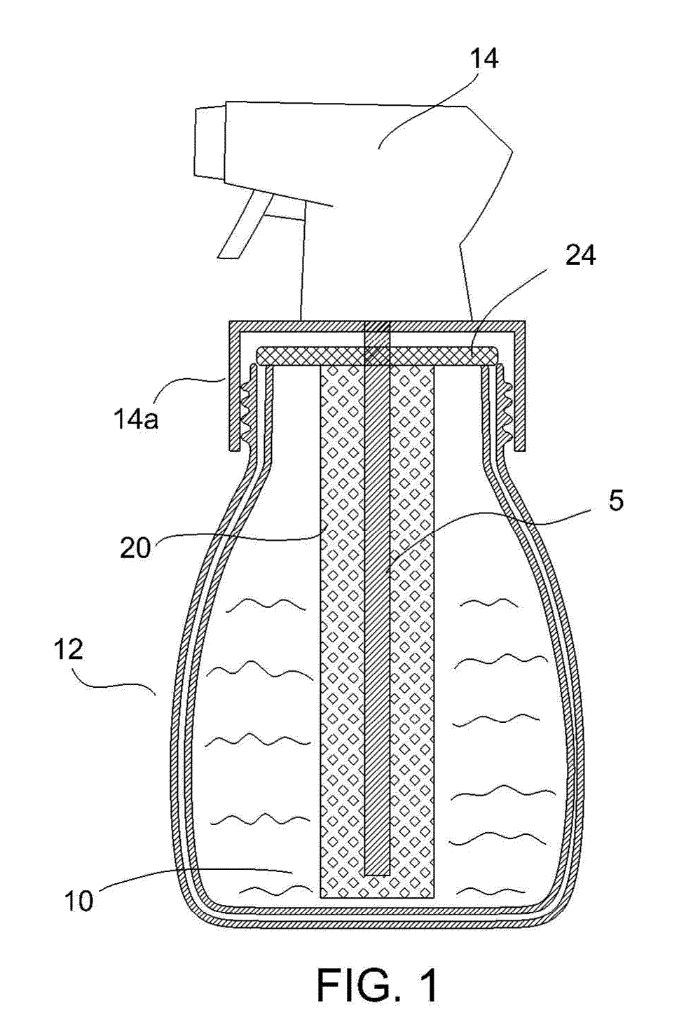

FIG. 1 is a cross-sectional view of a spray bottle apparatus 1 for use in an embodiment of the subject system. Spray system apparatus 12 has a standard trigger spray head 14 configured to engage and fit on a wide-mouth style container 12. In accordance with the invention, spray head 14 also has a diptube 5 for drawing the liquid contents of the container. In FIG. 1, recharge insert 10 is shown in relation to container 12, spray head 14 and diptube 5. Recharge insert 10 is described in further detail below.

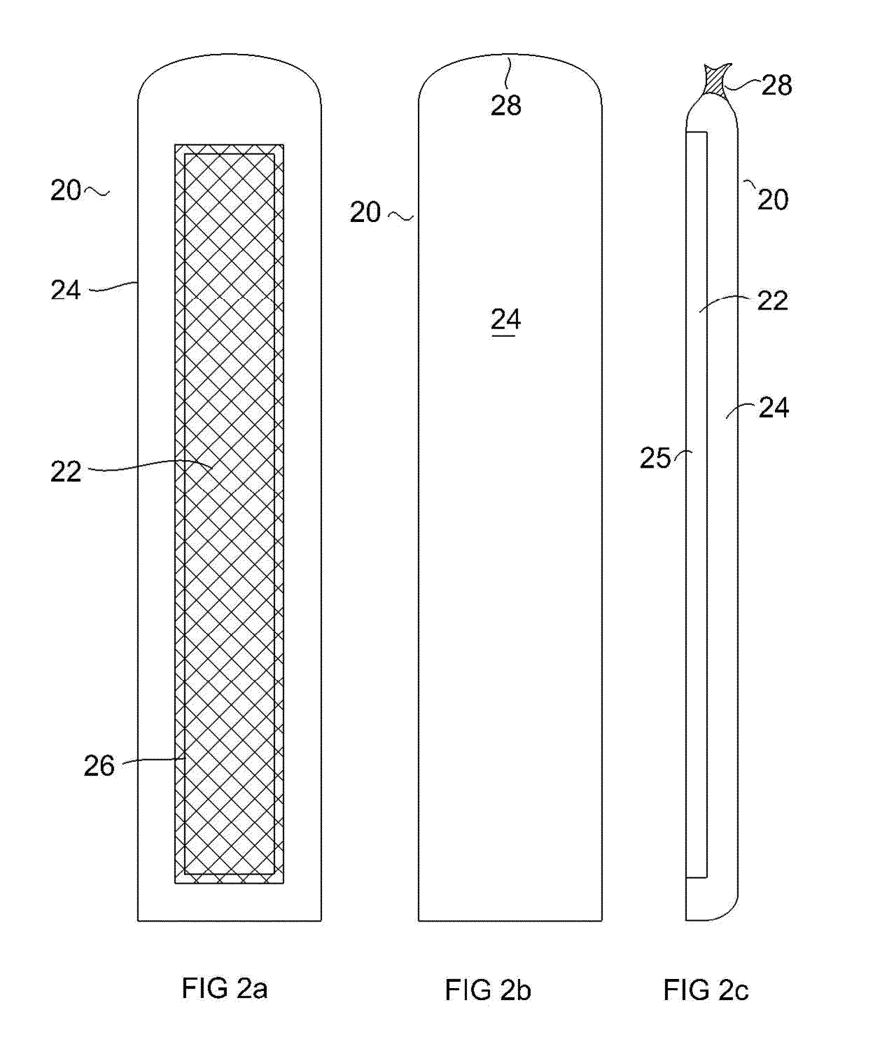

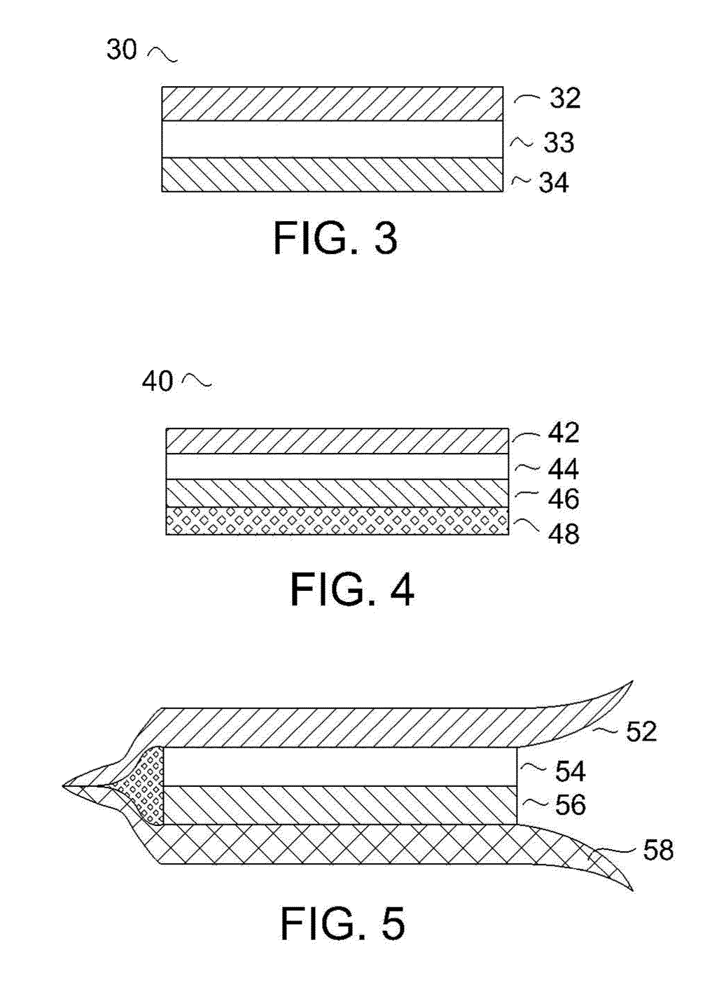

FIG. 2 b is a rear elevation view of the opened recharge insert assembly 20 shown in FIG. 2 a showing backing 24 which is suitable for printed advertising, directions or the like.

FIG. 5 is a cross-section of a further embodiment of a multi-ply recharge insert assembly 50 wherein outer packaging layers 52 and 58 have been partially peeled away to expose functional insert layers 54 and 56. Void 59 is depicted in this figure between sealed layers 52 and 58.

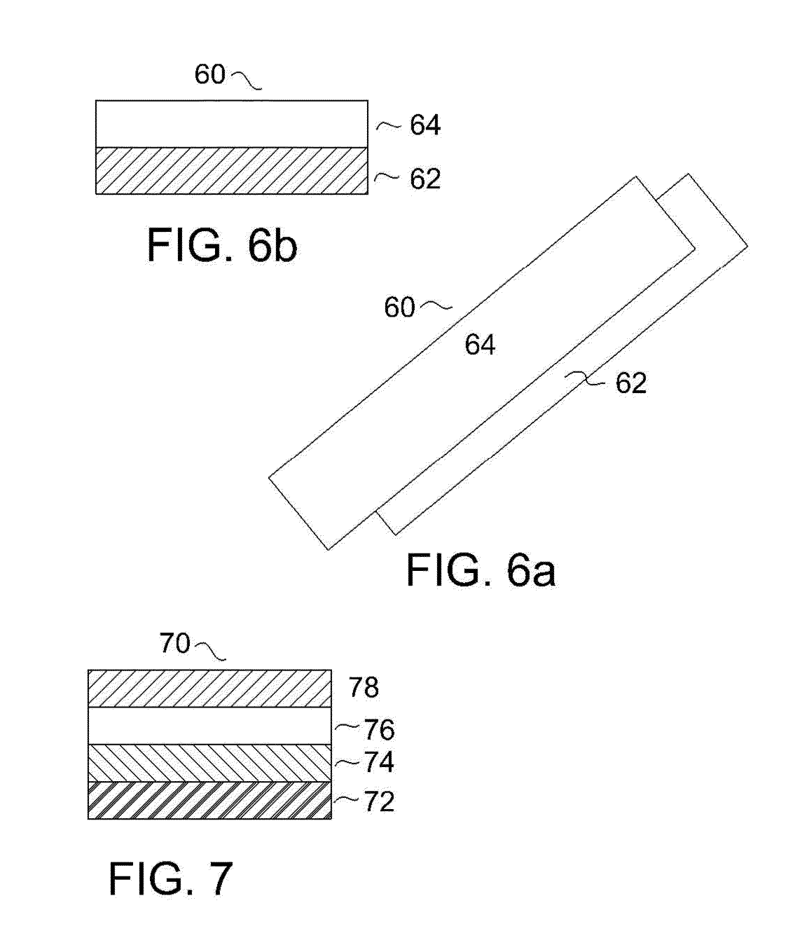

FIG. 6 a is a perspective view of an embodiment of recharge insert assembly 60 having a two-ply structure, wherein backing 62 is shown in relationship to functional insert layer 64. FIG. 6 b is an end view of the two-ply structure of the recharge insert assembly 60 shown in FIG. 6 a.

FIG. 7 is an end view of an embodiment of recharge insert assembly 70 having a four-ply structure having lower barrier layer 72, functional insert layer 74, porous mesh layer 76, and upper or outer barrier layer 78.

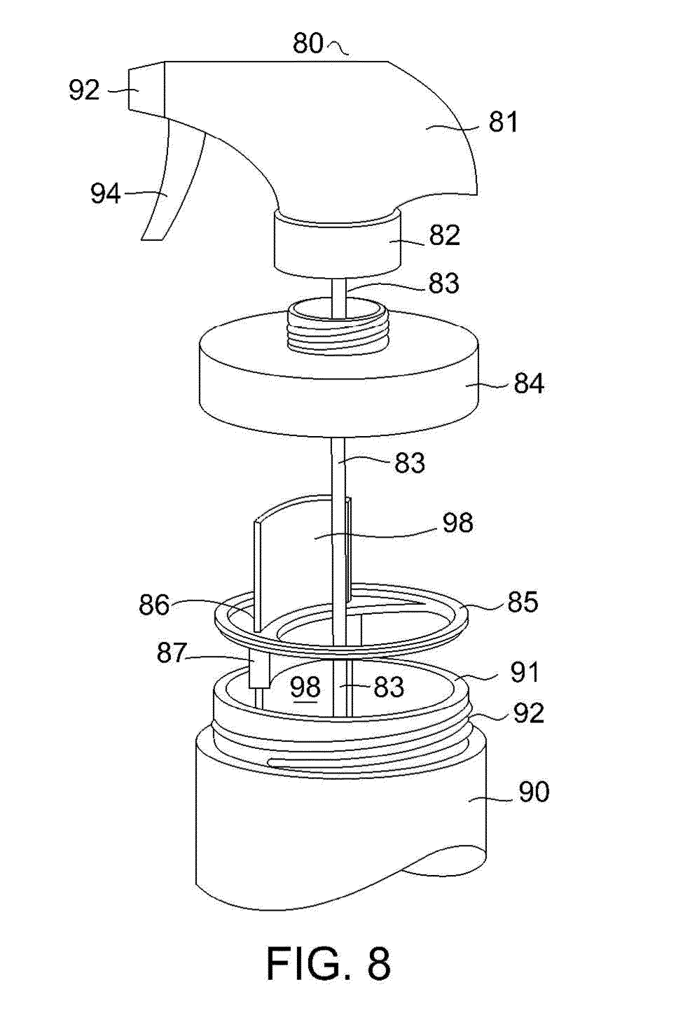

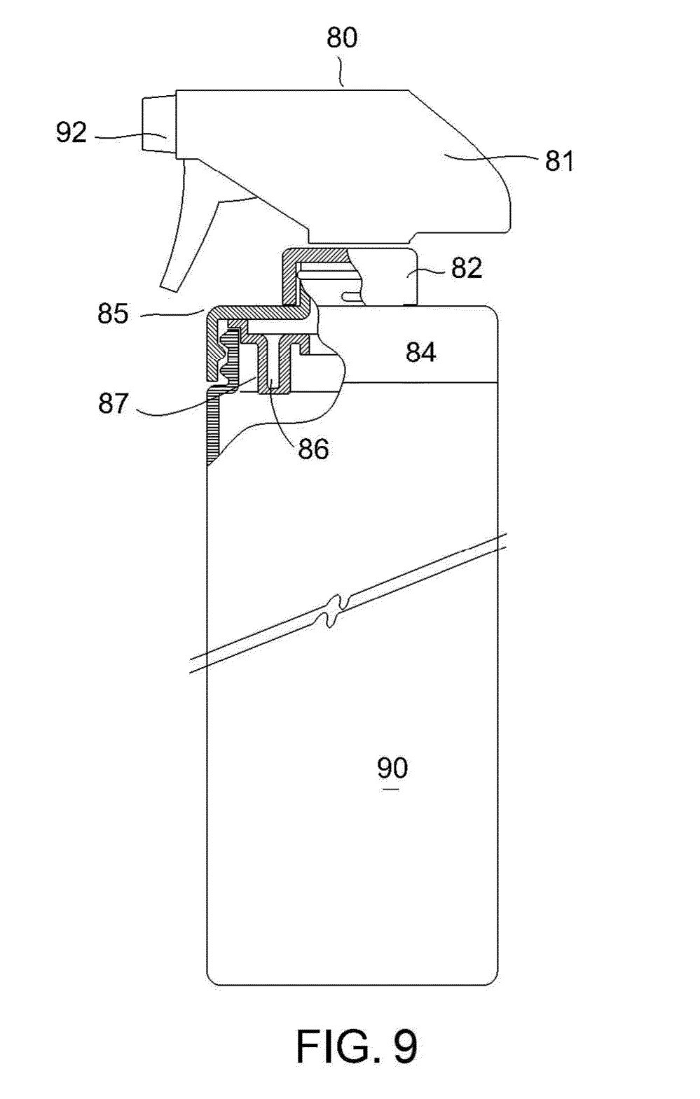

FIG. 8 is an exploded view of an embodiment of the subject recharge insert assembly 80 having spray head 81, nozzle 92, trigger 94, diptube 83 and screw cap 82 for engaging screw threads on collar 84. Collar 84 is configured to be placed in the top part of container 90 and is adapted to hold a recharge insert in opening 86, which is reinforced in this embodiment by descending portion 87. In this manner, a recharge insert will be held upright near the side wall of the bottle for easy viewing of the labeling. Collar 84 may be screwed onto container 90 with threads 92 at container opening 91 which engage insert adaptor 85 provided with an opening 86 and reinforced by a descending portion 87. In this Figure, spray recharge insert 98 has been placed partially in insert adaptor 85 and a portion of insert 98 can also be seen within container 90.

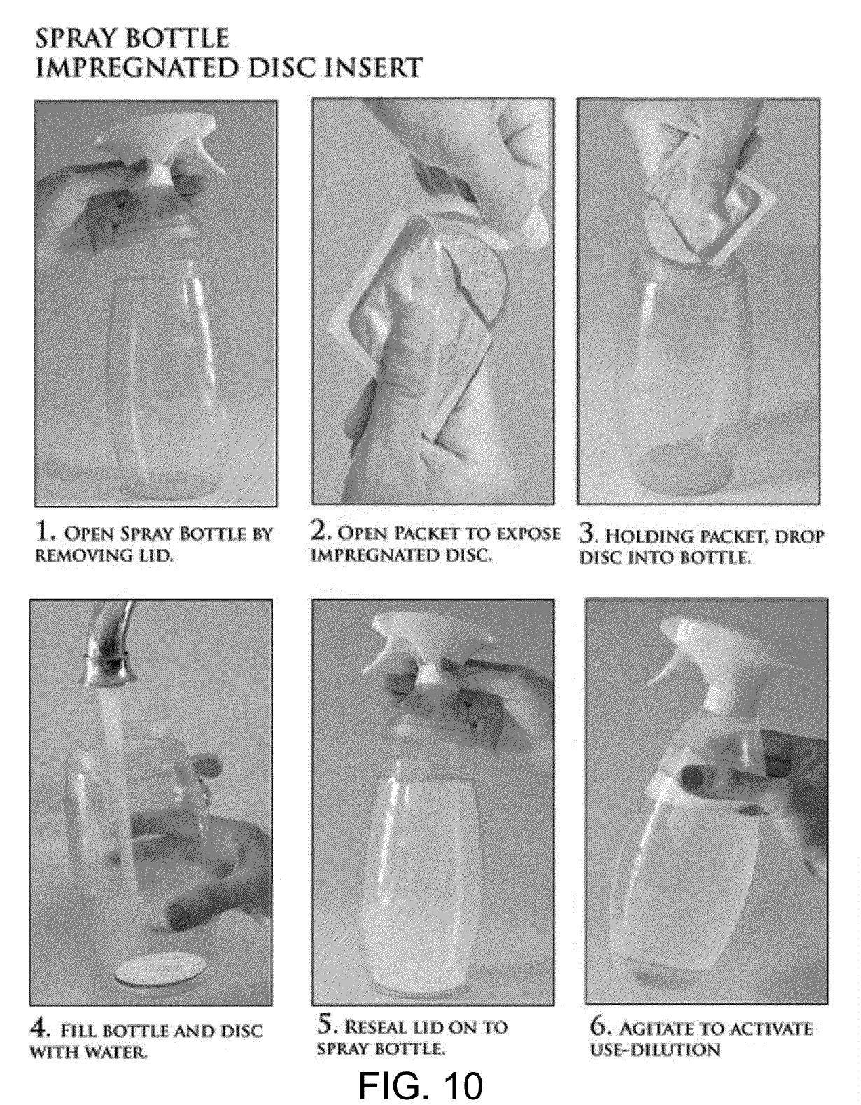

FIG. 10 shows photographic views of the recharge insert assembly and the following: introducing the insert; filling the container with water to form the application fluid from the concentrate in the insert.

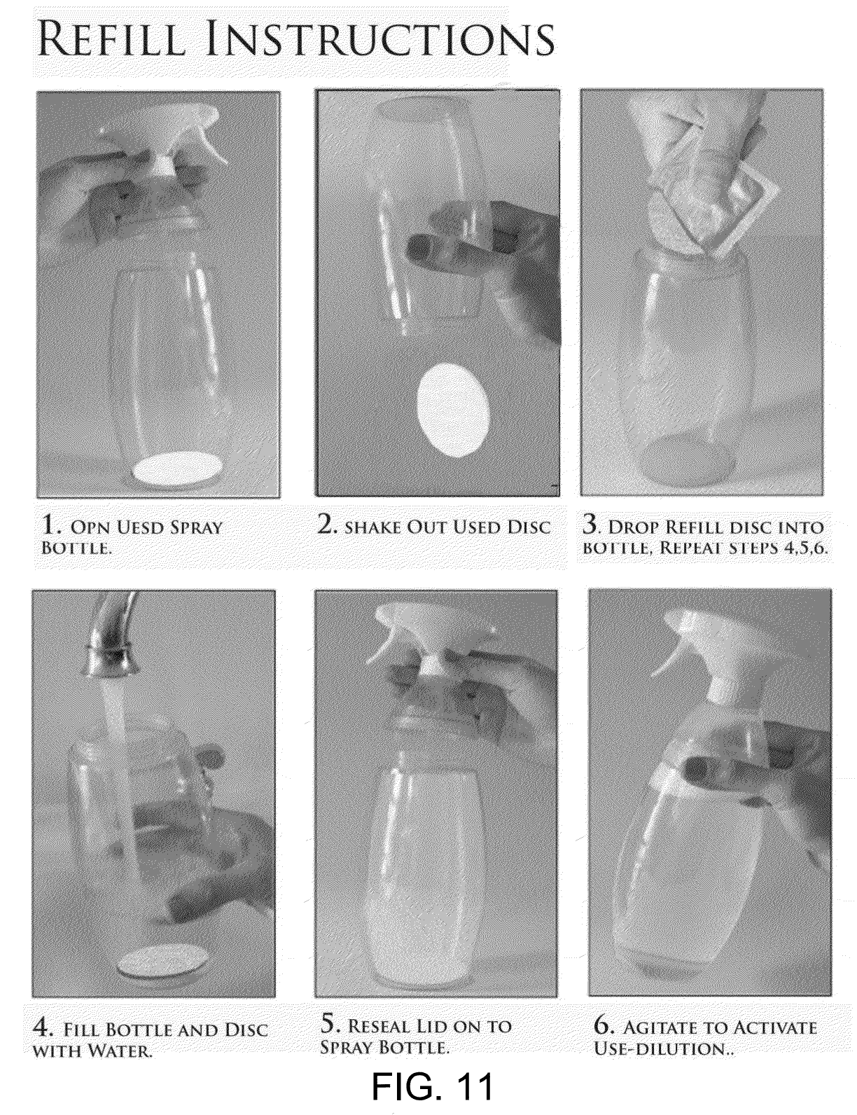

FIG. 11 is a cross-sectional view of a spray bottle apparatus for use in the rechargeable liquid spray system of the invention.

This invention provides an easy-to-use and safe-to-handle device for creating ready to use cleaning, sanitizing, degreasing, and/or disinfecting spray bottle solutions. The recharge insert is an entirely self-contained device which is designed exclusively for use with the wide-mouth spray bottles and spray heads in accordance with the invention. The compact, stand-alone insert makes it incredibly simple to recharge spray bottle solutions, and to thereby substantially reduce solid waste landfill contamination. They will also reduce the enormous shipping, handling, and storage cost associated with their prolific use commercially and at home.

Suitable translucent bottles having a satisfactorily wide container opening are commercially available in 16, 24 and 32 ounce sizes from Tablecraft, located in Gumee, Ill.

In addition to being easier to use, this new insert device is designed to accommodate use of larger dimensions of nonwoven materials without regard for the fiber blends involved that can effectively deliver significantly larger amounts of the concentrates. That's because the treated nonwoven cores of this new insert device are not ultra-sonically formed into sleeves, but instead are cut to the same dimension of about 1 inch by 8.5 inches, which represents as little as 8.5 sq. inches, or, potentially up to about 68 sq. inches of variable basis weights and fiber blends. Whereas that option can significantly expand loading capacity, it also mandates that the carrier device facilitate easy insertion and extraction of the impregnated nonwoven material into and from the dilute solution, and that it provide structural support for the nonwoven material when in the solution.

The unique insert is structurally designed to provide a mechanism that simplifies the procedure for creating a use-dilution while eliminating the need to handle or touch the cleaning, sanitizing or disinfecting agents impregnated into the nonwoven core in the process of doing so.

With this new insert device, the opportunities for creating a cleaning, sanitizing, degreasing or disinfectant use-dilutions are expanded considerably, due in part because the activation process itself is far more simplified. An end-user simply removes the two-piece top from the wide-mouth bottle, empties and refills the bottle with fresh water, removes the releasable film from one side of the pouch, and then places the remaining insert into the filled bottle thereby allowing the concentrate to be diluted and create a ready-to-use solution. The spray bottle as rendered in one of the drawings illustrates how this system can be assembled without having to build a whole new set of expensive spray bottle tooling and molds. A spray bottle system of this type is needed to accommodate the 2-inch wide insert of the invention which is a key element of the new concept, and which will be described in greater detail by the following.

The preference for use of the recharge system of the invention was driven by its demonstrated ability to reduce solid waste and both shipping and inventory costs by up to 90%.

The subject recharge insert may be seen to facilitate simplification of several essential aspects of the spray system technologies, including reduced dependence on super concentrated formulations, less complicated fiber specifications and blends for the nonwoven cores, and easier to use inserts that include labels for creating specific ready-to-use cleaning solutions for use in wide-mouthed, unlabeled spray bottles, thereby reducing the necessity for using dedicated, pre-labeled spray bottles.

### Example 1

The formulation for EPA Registration No. 62401-7, an approved food contact cleanser and sanitizer, was impregnated into a 22 lb. needlepunch composite 50/50 blend of polypropylene and polyethylene fibers with a thickness of about ⅜ inches. In accordance with the approved EPA registration, a 110% add-on of this formulation was uniformly slot-coated onto, or impregnated into this matrix, which was then cut into rectangular pad-inserts, measuring 1.5 inches in width by 2.5 inches in length. The resulting pad had a treated weight of 3.79 grams, of which 1.98 grams was the approved formulation.

The pad/insert was then dropped into the wide-mouthed spray bottle, where it settled neatly on the bottom surface, leaving space for the bottom of the diptube to access the entire outer circumference of the bottle's bottom surface to facilitate complete withdrawal of the activated use-dilution from the spray bottle. Twenty-four ounces of clean water was then added to fill the spray bottle, which was then sealed and shaken until all of the treatment formulation was dissolved, as evidenced by the colorless pad/insert.

The trigger was then activated and yielded a 200 PPM quaternary solution, as specified by the approved food contact surface cleaning and sanitizing EPA Registration No. 62401-7.

### Example 2

A proprietary glass and window cleaning formulation, containing a volatile component requiring a barrier packaging film to maintain stability, was used to prepare this sample. This concentrate included dipropylene glycol n-butyl ether as the solvent, and potassium hydroxide for adjusting the pH. For this product, an effective 24-ounce use dilution requires that the concentrate comprise an add-on of at least 325% of the basis weight of the same 22 lb. composite and 50/50 blend of fibers as employed in Example 1, supra. After this composite was slot-coated with the required add-on, and was cut into rectangular pad-inserts measuring 1.5 inches in width by 2.5 inches in length, the treated pad inserts weighed 7.66 grams, of which the added concentrate comprised 5.86 grams.

Typically, nonwoven composite will readily absorb and hold up to four times their basis weight without releasing the add-on prematurely. The 325% add-on was well within that range, and did not leak from the barrier film pouch in which it was subsequently wrapped.

The treated pad-insert was then dropped into the wide-mouthed spray bottle, and settled neatly on the bottom surface, leaving space for the end of the diptube to access the entire circumference of the bottle's bottom surface to facilitate withdrawal of the activated use-dilution. Twenty-four ounces of clean water was then added to fill the spray bottle, which was then sealed and shaken until the entire treatment formulation was dissolved, as evidenced by the colorless pad-insert.

The trigger was then activated and used to spray the glass cleaning formulation onto a variety of glass and other polished surfaces, all of which were free of any dust, dirt, or greasy residue as a result of the use of the formulation.

The invention herein contemplates the use of a three-piece, wide-mouthed spray bottle which comprises a three-piece unit comprising (1) a bottle with an opening of 1.5 to 3 inches, incorporating screw-threads for attachment of (2) an adaptor-cap which incorporates female screw-threads for attachment to the bottle, and screw-threads for attaching (3) a pump-sprayer device with a trigger handle via a second opening of about 1 inch in diameter. What makes the three-piece unit of the invention unique is the two different size openings of the adaptor-cap, which serves two purposes. The first is to allow for the use of standard pump-spray device or triggers, which are widely manufactured for one-inch diameter openings, and are intended for use with this invention. In this way, if the pump spray device or trigger does fail, the entire wide-mouthed bottle does not need to be replaced. The second important purpose is the ability of the adaptor-cap to accommodate screw-threads for properly attaching and sealing this adaptor-cap to the wide-mouthed opening of between 1.5 and 3 inches in diameter, and preferably at least two inches in diameter. This significantly larger opening makes it much easier to fill the spray bottle with water, and also much easier to clean and to then re-fill with water, than is the case with the standard 1-inch diameter opening. This wide-mouthed bottle is also ideally suited for accepting concentrate-inserts in any format for creating and activating a wide variety of spray bottle solutions, including hard surface cleaners, sanitizers, and disinfectants; plant cleaners and nutrients; pet care products; carpet and fabric care products; odor control products; and virtually any product that can be delivered in a spray bottle format. Significantly, such concentrates can be provided in virtually any form, including liquid concentrates in water-soluble pouches or in measured amounts; as treatments, for example, on fabric composites which can't be broken, swallowed or spilled, or even as powders, capsules or tablets. In the world of spray bottles, there has heretofore been no bottle construction as described by the applicant. The applicant, in fact, has obtained a design U.S. Pat. No. D671,004 S, supporting its uniqueness.

It will be recognized by those skilled in the art that many variations of the above descriptions may be employed in other embodiments of the subject invention.

1. A three-piece rechargeable dispenser comprising a wide mouth bottle portion having an opening of 1.5 to 3.0 inches in diameter and incorporating screw threads for attachment of said bottle portion to an adaptor cap having a first opening corresponding to said bottle portion's wide opening, said adaptor cap having a second opening of about 1 inch in diameter and screw threads for attachment of a pump sprayer device constructed with plastic components with a trigger handle, and a chemical refill insert configured to be disposed within said dispenser, said refill insert being adapted for containing and storing a measured amount of concentrate agent, said insert being disposed within said bottle portion of said dispenser, wherein when said pump sprayer device is connected to a dip tube, and on activating the trigger handle, solution is caused to be delivered from said bottle portion of said dispenser.

2. The system of claim 1, wherein the backing layer of barrier film packaging material layer of the rechargeable spray insert is a plastic film.

3. A rechargeable dispenser according to claim 1 wherein said pump sprayer device is suitable for repeated use.

4. A rechargeable dispenser according to claim 1 wherein said bottle has an opening of about 2 inches in diameter.

5. A rechargeable dispenser according to claim 1 wherein said bottle is suited for accepting concentrate inserts which on activation will provide a wide variety of spray bottle solutions.

6. A rechargeable dispenser according to claim 5 wherein said concentrate insert includes a hard surface cleaner, sanitizer, disinfectant, plant cleaner, plant nutrient, pet or animal care product, carpet cleaner, fabric freshener or odor control product.

7. A rechargeable dispenser according to claim 6 wherein said concentrate is a liquid.

8. A rechargeable dispenser according to claim 1 wherein said bottle is made of polycarbonate.

9. A rechargeable dispenser according to claim 1 wherein said concentrate is a particulate product, the particles being of nanoparticle size.

10. A rechargeable dispenser according to claim 1 wherein said particles are incorporated into a nonwoven fabric strip or pad.

11. A method of recharging a spray bottle dispenser according to claim 18 which comprises the steps of removing the pump sprayer device and adaptor cap to open the spray bottle dispenser, then introducing a measured amount of concentrate or refill into the empty bottle, refilling the bottle with water and reattaching the adaptor cap and pump sprayer device to the bottle.

12. A method according to claim 11 wherein said concentrate is a liquid, pill, capsule or powder impregnated nonwoven fabric strip or pad.

13. A rechargeable dispenser according to claim 5 wherein said concentrate is a water soluble pouch.

14. A rechargeable insert according to claim 5 wherein said concentrate insert is a powder.

15. A rechargeable insert according to claim 5 wherein said concentrate insert is a liquid.

16. A rechargeable insert according to claim 5 wherein said concentrate insert is a tablet.

17. A recharge insert according to claim 12 wherein said sprayhead is connected to a diptube wherein said concentrate is incorporated into a nonwoven fabric in the shape of an elongated strip or pad.

18. A three-piece rechargeable dispenser comprising a bottle portion having an opening of 1.5 to 3 inches in diameter and incorporating screw threads for attachment of an adaptor cap having a second opening of about 1 inch in diameter and screw threads for attachment of a pump sprayer device being connected to a dip tube which on activation of said trigger handle, solution containing concentrate agent formed from an insert disposed within said bottle portion is caused to be delivered from said bottle portion of said dispenser.

19. A rechargeable dispenser according to claim 18 wherein said disc has a diameter of about 1½ to 2¾ inches.

20. A recharge dispenser comprising a combination of the structure of claim 21 with an easily-opened packet containing said elongated woven insert impregnated with concentrate of a member selected from the group consisting of cleansing, sanitizing, degreasing and disinfectant agents.

21. A recharge dispenser according to claim 18 wherein said elongated material has a width of about 1.5 to 2 inches.

22. A recharge dispenser according to claim 18 wherein said elongated material is a disc constructed of a nonwoven composite material.

23. A rechargeable system according to claim 18 wherein the insert has a dimension of about 1 inch by 8.5 inches.
